(19) United States
(12) Patent Application Publication
(10) Pub. No.: US 2005/0079473 A1
(43) Pub. Date: Apr. 14, 2005

(54) Articles of manufacture having a chalkboard like section for educational and entertainment value

(76) Inventors: Mitchell Smith, Tenafly, NJ (US); Jennifer Wallace, Ramsey, NJ (US); Theresa Rasmussen, Mahwah, NJ (US); Merwin Smith, Tenafly, NJ (US)

Correspondence Address: DARBY & DARBY P.C., P. O. BOX 5257, NEW YORK, NY, 10150-5257, US

(21) Appl. No.: 10/684,253

(22) Filed: Oct. 10, 2003

(51) Int. Cl. G09B 11/00; B43L 1/00

(52) U.S. Cl. 434/162; 434/408

(57) ABSTRACT

In one exemplary embodiment, an interactive table cloth is provided and includes a foldable substrate processed to receive chalk on a writing surface thereof and being washable so as to permit erasing of any chalk marks made on the substrate such that the substrate appears substantially as new after cleaning. The table clothing also has a border formed around and attached to a peripheral edge of the substrate. The border is formed of a second material that is different from a first material forming the substrate. A guide is printed on the writing surface and being indicative of where chalk is to be applied. The guide being formed of a third material different than the first material and in one embodiment, the guide is permanently adhered to the writing surface by means of a heat transfer printing process and in another embodiment, the guide is removably disposed on the writing surface.

### TECHNICAL FIELD

The present invention relates to articles of manufacture that have educational and entertainment value and can be used in institutional settings more particularly, relates to an article of manufacture that has a section that is formed of a synthetic material that has chalkboard like characteristics.

### BACKGROUND

As is known, chalkboards have long been used as both an educational tool and to provide hours of entertainment to a child. A conventional chalkboard is in the form of a blackboard which is constructed with a non-magnetic surface on which chalk can be written and easily erased. Two materials that chalkboards are commonly made from are Duracite and Vitracite and an outer surface of the board is provided in a color, such as green or black, that easily permits chalks of various colors to be detected. A wooden or metal frame typically extends around the periphery of the chalkboard writing surface. While, conventional chalkboards provide a suitable educational and entertainment tool, there are a number of disadvantages associated therewith. First, chalkboards can be very heavy and cumbersome in size and therefore, they are often either directly attached to a wall or part of a vertical frame that supports and holds the chalkboard. In either event, they are very heavy and are not easily transportable from one location to another and they are most certainly very bulky items that can not be easily stored. Also, the chalkboard is generally fixed in either a perpendicular position or substantially perpendicular position and therefore, the user must stand before the chalkboard to use it. Over time, the child will likely become tired of standing and will likely stop the session not because the child is bored but the child is tired of standing or kneeling in front of the chalkboard. This also can lead to problems or difficulty in cleaning the chalkboard due to its fixed position. Also, the child's hand and arm will become fatigued from holding them up for a long extended period of time. In addition, it is usually difficult for the child to see what the child is writing on the board due to the vertical nature of the blackboard and the child being very close to the front of the blackboard.

What has heretofore not been available is a transportable, foldable article that has a substrate that has a chalkboard like section as a part thereof that serves not only as an educational tool but also provides entertainment value and permit any number of different types of indicia to be printed or otherwise disposed thereon.

### SUMMARY

In one exemplary embodiment, an interactive table cloth is provided and includes a foldable substrate processed to receive chalk on a writing surface thereof and being washable so as to permit erasing of any chalk marks made on the substrate such that the substrate appears substantially as new after cleaning. The table clothing also has a border formed around and attached to a peripheral edge of the substrate. The border is formed of a second material that is different from a first material forming the substrate. A guide is printed on the writing surface and being indicative of where chalk is to be applied. The guide being formed of a third material different than the first material and in one embodiment, the guide is permanently adhered to the writing surface by means of a heat transfer printing process and in another embodiment, the guide is removably disposed on the writing surface (e.g., the guide can be an adhesive backed decal or static cling decal). Alternatively, the guide can be formed using a permanent screen printing process in which predetermined indicia, such as a game board, is laid on the outer surface of the substrate. This type of printing process is typically used for creating indicia, such as text or a decorative pattern or the like on a T-shirt.

In yet another embodiment, the table cloth or other article of manufacture, such as a placemat, is part of a kit that comes with a plurality of chalk pieces and a cleaning container, such as a spray bottle, for applying a liquid to the writing surface for cleaning thereof. The border section of the article preferably includes a feature, formed as integral part thereof, that receives and stores the chalk pieces and the spray bottle. For example, a pouch or the like can be formed as part of the border section and it receives the chalk pieces and the spray bottle for convenient and secure storage thereof.

The structure of the guide is highly variable since it can be in the form of printed indicia that acts as an educational tool or it can be printed matter that conveys some type of theme or it can be in the form of a corporate logo or the like. For example, the guide can be in the form of composition lines printed across the writing surface to assist the user in learning and practicing writing individual letters and/or words. Similarly, the guide can be one or more music bars for practicing writing musical notes and/or songs, etc. The guide can also be in the form of a printed game board, such as a checkerboard, a chess board or a hang man game illustration. The guide can have an associated theme, such as a sport, or it can take in part the form of a corporate logo that has some interactivity where the user can apply chalk thereto, etc. In one embodiment, the guide is in the form of a coloring mask that is disposed on the writing surface and indicates to the user where to apply the chalk in order to draw an image or write letters or text that are defined by the coloring mask.

The border section can also have indicia formed thereon which can be related to a theme conveyed by the guide or the indicia can be a corporate logo or the like.

### BRIEF DESCRIPTION OF THE DRAWING FIGURES

The foregoing and other features of the present invention will be more readily apparent from the following detailed description and drawing figures of illustrative embodiments of the invention in which:

FIG. 1 is a perspective view of an interactive table cloth according to one exemplary embodiment and placed on a table for use by children, etc.;

FIG. 2 is a perspective partially cut away view of a corner of the table cloth of FIG. 1;

FIG. 3 is a local perspective view of a section of the table cloth of FIG. 1 and a spray bottle for use in cleaning a writing surface;

FIG. 4 is a local perspective view of a section of the table cloth and spray bottle of FIG. 3 and an integral pocket for storing the spray bottle, etc.;

FIG. 5 is a local perspective view of a section of the table cloth of FIG. 1 along with an integral pocket for storing items, such as chalk;

FIG. 6 is a local perspective view of the table cloth of FIG. 1 illustrating pre-printed indicia formed on a writing surface thereof;

FIG. 7 is a local perspective view of a section of the table cloth and the indicia of FIG. 5 being permanently adhered on the writing surface using conventional techniques;

FIG. 8 is a local perspective view of a section of the table cloth including pre-printed indicia in the form of compositional writing lines;

FIG. 9 is a local perspective view of a section of the table cloth illustrating the placement of a permanent decal on a writing surface thereof;

FIG. 10 is a local perspective view of a section of the table cloth illustrating the placement of removable indicia on a writing surface thereof;

FIG. 11 is a local perspective view of a section of the table cloth illustrating removable indicia in the form of a coloring mask;

FIG. 12 is perspective view of an interactive table cloth according to another exemplary embodiment and placed on a table for use by children, etc.;

FIG. 13 is a perspective view of a kit according to a first embodiment and including the table cloth of FIG. 1 and indicia that can be either permanently or removably placed on a writing surface of the table cloth; and

FIG. 14 is a perspective view a kit according to a second embodiment and including the table cloth of FIG. 1 and indicia that can be either permanently or removably placed on a writing surface of the table cloth.

### DETAILED DESCRIPTION OF PREFERRED EMBODIMENTS

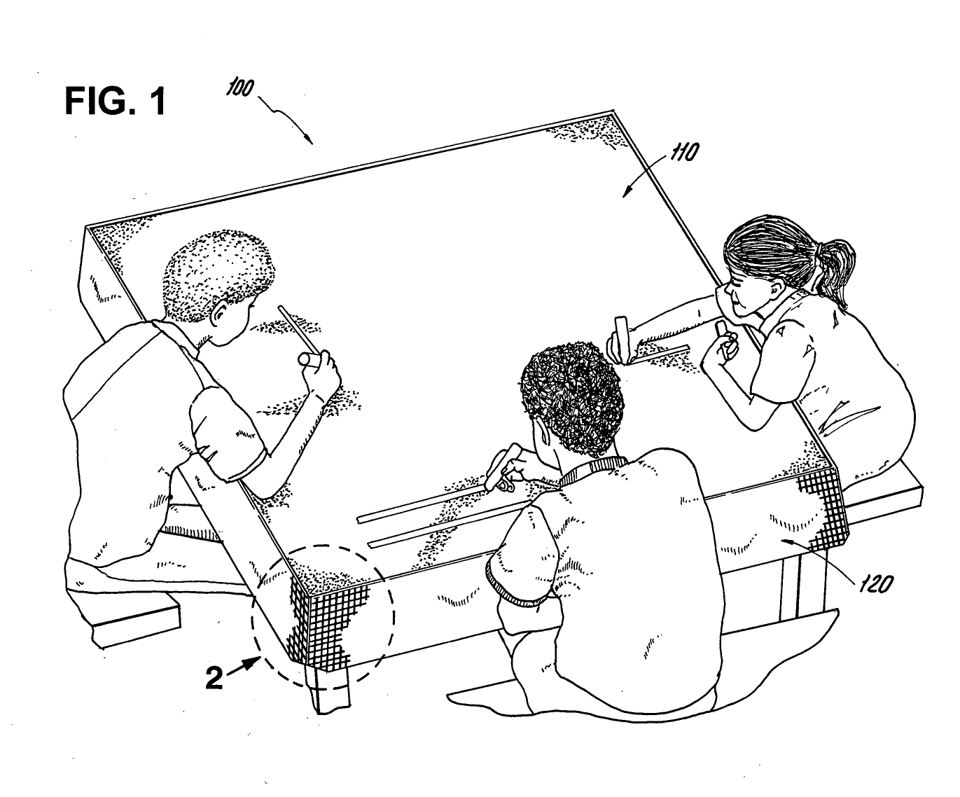

FIG. 1 is a perspective view of an article of manufacture according to a first embodiment, and more specifically, a table cloth 100 is illustrated. The table cloth 100 is generally formed of two sections, namely a first section or substrate 110 and a second section 120 that acts as a border and surrounds the periphery of the first section 110. The first section 110 is formed of a material that is processed to receive chalk in a manner in which the chalk can easily be erased and the first section 110 used over and over again. The material forming the first section 110 should not be rigid but rather is preferably formed of a synthetic fabric that has been treated so that it functions as a chalkboard, while at the same time, the fabric is readily foldable, etc. so that the table cloth 100 can be folded into a smaller size for storage, transportation, etc. thereof.

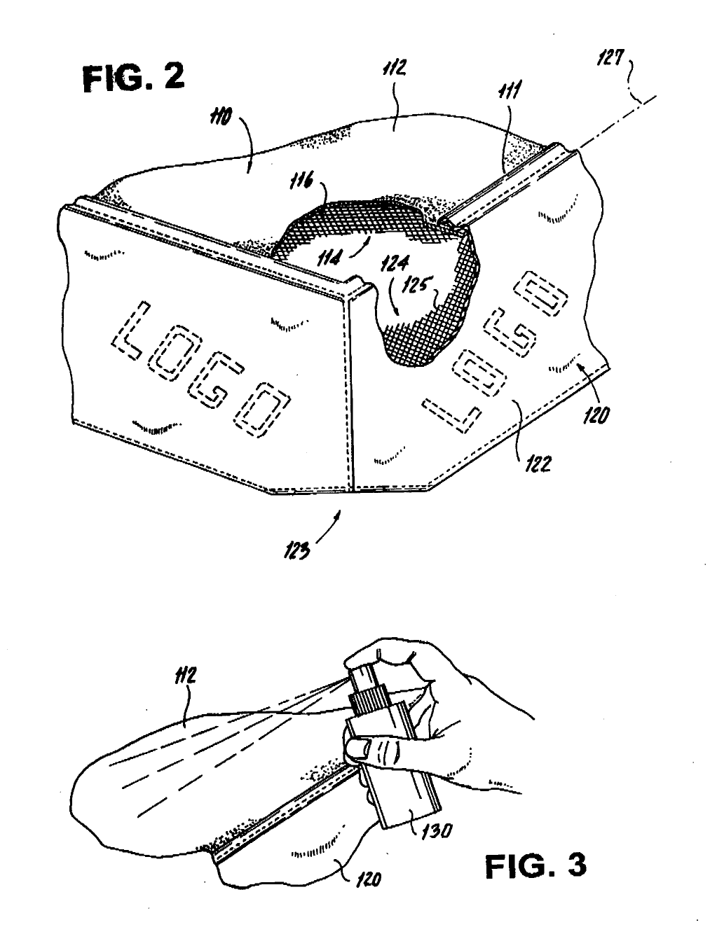

As shown in FIG. 2, the first section 110 includes a first face 112 and an opposing second face 114, with the first face 112 being the surface that has been processed to act like a chalkboard (i.e., receive chalk in an erasable manner). The first face 112 thus typically has a dull finish since this functions as the writing surface as opposed to the second section 120 which can have a glossy finish. Moreover, the color of at least the first face 112 of the first section 110 is a dark color to permit various colored chalk marks to be easily discernable thereon when a user writes on the first face 112. For example, the first face 112 can have a black or dark green color; however, it will be appreciated that any number of colors, including dark and light colors, can be used to form the first section 110.

While the first section 110 is shown in FIG. 1 as having a generally square shape, it will be appreciated that the first section 110 can have any number of other shapes, such as a rectangle, a circle, an oval, triangle, a diamond, etc., since it is more a matter of design choice as to the specific shape of the first section 110.

The opposing second face 114 of the first section 110 is the face that typically sits against a support surface and therefore, the second face 114 does not act as a writing surface. In one embodiment, the second face 114 has a web 116 formed thereon to provide some additional support, integrity and robustness to the first section 110. The web 116 is in the form of a mesh webbing (threaded web) that extends across the second face. The web 116 also makes the first section 110 easier to cut and attach to another piece, such as the border section 120. The web 116 likely will have a color that is in contrast with the color of the first face 112 and therefore, in one embodiment, the first face 112 has a black color, while the web 116 has a white color.

One exemplary type of flexible chalkboard like material that is suitable for use as the first section 110 is a synthetic oil cloth that is commercially available from Oil Cloth International of Los Angeles, Calif.

The border section 120 is preferably formed of a material that is different from the material forming the first section 110. For example, the border section 120 can be formed of a synthetic material that does not have chalkboard characteristics and in one embodiment, the border section 120 is formed of a plastic material, such as PVC. The border section 120 has a first face 122 and an opposing second face 124 such that when the first section 110 and the border section 120 are attached to one another, the first faces 112, 122 are side-by-side, while the second faces 114, 124 are side-by-side.

The border section 120, especially the first face 122 thereof, can be provided in a number of different colors and also in any number of different patterns or decorative surfaces. The border section 120 can also have indicia formed thereon, such as a logo, text (e.g., a saying), a drawing or caricature, or symbols or the like, such as music lines or alphabet lines to encourage a child user to write either musical notes or practice writing letters and/or words. In a corporate application, the border section 120 can have a corporate logo thereon in one or more location around the border section 120. In one exemplary embodiment, the border section 120 has a checkerboard pattern formed across the first face 122 thereof. The border section 120 is formed of a material or is processed so that the first face 122 is a wipeable surface in that if the user accidentally makes a mark thereon with a marker or even chalk, the user can easily wipe the surface clean; however, it will be understood that while the border section 120 is wipeable, it has not been processed to act as a chalkboard and therefore it is not intended to serve as a writing surface.

As with the first section 110, the border section 120 preferably has a web 126 formed on the second face 124 thereof to provide some additional support, integrity and robustness to the border section 120. The web 126 is preferably in the form of a mesh webbing (threaded web) that extends across the second face. The web 126 also makes the border section 120 easier to cut and attach to another piece, such as the first section 110. The web 126 can be identical to the web 116 in that it can be a white threaded mesh.

The illustrated table cloth 100 is constructed in the following manner. The first section 110 is cut to the appropriate size and shape. The border section 120 is typically formed of a number of separate sections that are cut to the appropriate size and shape and then are attached to one another along edges and to the first section 110 so as to form a complete border around a peripheral edge 111 of the first section 110. More specifically, two ends of the border section 120 can be formed to have a beveled edge 121 that is joined to the beveled edge 121 formed as part of the adjacent individual border section. An outer peripheral edge 123 of the individual border section is preferably turned over and stitched to itself so as to provide a clean peripheral edge to the border section as opposed to a sharp cut edge. The turned edge can be attached to the rest of the border section piece by using simple stitching techniques.

The individual border section pieces each has an inner edge 125 that is attached to the peripheral edge 111 of the first section 110 so that the inner edges 125 of the individual border section pieces define a peripheral border of the writing surface on the first face 112. More specifically, each inner edge 125 is preferably attached to the peripheral edge 111 of the first section 110 using a turn down hem stitch. When this technique is used, the border section 120 is laid over the first section 110 such that the first face 122 faces down towards the first face 112 of the first section 110 and the inner edge 125 of the border section 120 is generally aligned with the outer peripheral edge 111 of the first section 110. These two edges 125, 111 are stitched or otherwise attached to one another and then the border section 120 is folded over along a fold line 127 so that the first face 122 of the border section 120 is no longer facing the first face 112 but rather the two first faces 112, 122 are facing the same way and are side-by-side relative to one another. After the border section 120 is folded over, a second stitch is made through the border section 120 and the first section 110 along the peripheral edge 111 thereof so as to securely attach the two sections 110, 120 to one another.

By using a turn down hem stitch, the folded section of the border section 120 acts as a clean border for the writing surface defined on the first face 112 of the first section 110 and is constructed so that a seal is formed between the first face 112 of the first section 110 and the folded border section 120. Preferably, this seal is a liquid tight seal so that when the writing surface is cleaned after use, as will be described hereinafter, the cleaning liquid is contained within the boundaries of the writing surface and is not permitted to flow between the first section 110 and the border section 120 at the location where the two are joined.

Because the first face 112 of the first section 110 has been treated or processed so that it acts like a chalkboard in that it receives chalk or the like and permits easy erasing of the chalk, the first face 112 provides and defines a writing surface. Chalk can thus be used to write or draw on the first face 112 in a manner essentially like how chalk is used with a conventional blackboard and then the chalk markings are easily erased as discussed below. The cleaning of the writing surface (first face 112) is simple and straightforward in that the writing surface only need be wiped with a damp cloth to cleanly erase the chalk marks across the writing surface. For example, a damp cloth that has been wetted with water can be used or the user can apply water or some other type of other suitable liquid to the writing surface and then wipe the applied liquid across the writing surface, thereby removing the chalk marks and cleaning the writing surface for a next use. In one embodiment shown in FIG. 3, a spray bottle 130 is provided for holding a cleaning solution, such as water or WINDEX. Moreover, it will be appreciated that the outfit can be article can be machine washed (using household washing directions, and therefore, this is one way of cleaning the surface after use or for a periodic wash of the article.

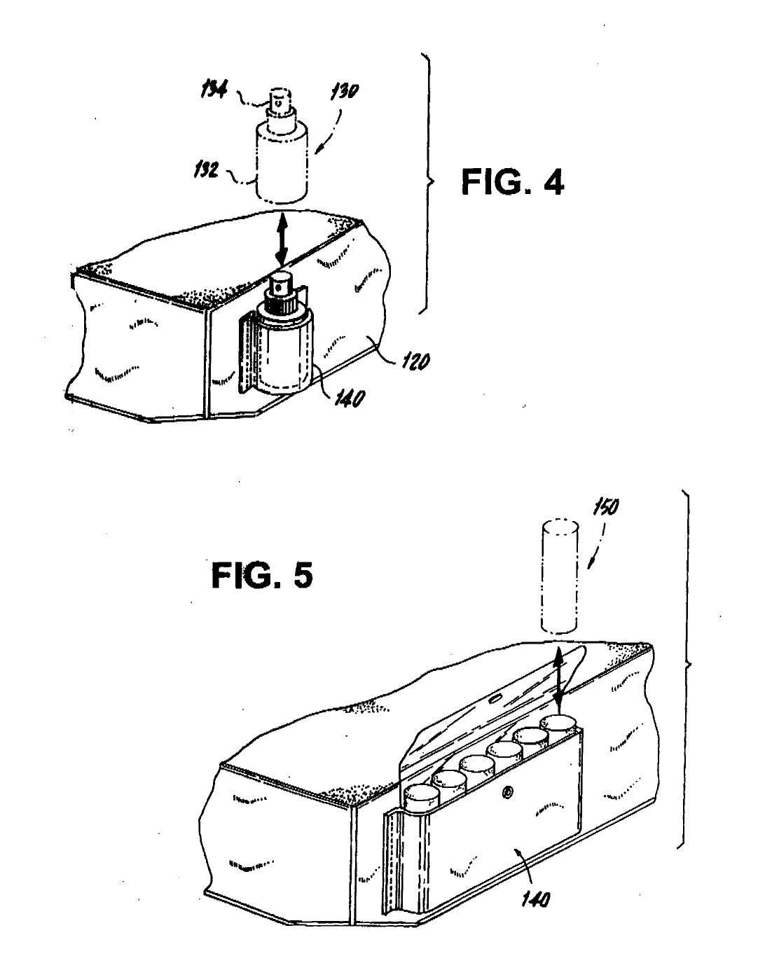

To contain the spray bottle 130 during the transportation or storage of the table cloth 100 or when the bottle 130 is not being used, the border section 120 can have a feature associated therewith for securely locating and holding the spray bottle 130. For example, the border section 120 can include an integral pocket 140 as shown in the embodiment of FIG. 4. The pocket 140 can be formed of the same material as the border section 120 or it can be formed of a different material and it is attached to one of the individual border sections by any conventional means, such as by stitching, an adhesive, hook and loop fasteners, etc. Preferably, the depth of the pocket 140 is sufficient to permit at least a base 132 of the spray bottle 130 to be received therein, with a nozzle 134 thereof protruding above and out of the pocket 140 to permit the user to easily identify and grasp the spray bottle 130.

It will also be appreciated that the pocket 140 can receive and contain a plurality of chalk pieces 150. As with the spray bottle 130, the chalk 150 is preferably received in the pocket 140 so that one end thereof protrudes out of the pocket 140 to permit the user to easily identify the color of the chalk.

While FIG. 5 only shows one pocket 140 located on one of the individual border sections, it will be understood that more than one pocket 140 can be provided as part of the border section 120. For example, one pocket 140 can be provided as part of each individual border section 120 to permit multiple users to have their own personal pocket 140 where they can store their own items, such as their own chalks, an eraser, spray bottle 130 or any other item that can be received therein.

Instead of providing a pocket 140, a hook and loop type fastener member can be provided to hold chalk, the spray bottle 130, etc. For example, a pair of hook members can be securely fixed to the first face 122 of the border section 120 in a space relationship and then a loop type strip is provided. To hold the chalk, spray bottle, etc. in place, the items are laid on the first face 122 between the two hook members and then the loop fastener strip is disposed across the items such that the ends thereof mate with the hook members in a releasable manner. The loop fastener strip preferably is snugly fit against the items so that it applies a force thereagainst sufficient to hold the items in place between the two hook members.

Preferably, the corners of the border section 120 are constructed such that there are no sharp edges as part thereof. This acts as a safety feature so that there are no sharp pointy edges that can easily poke or scrap against the body of the user. For example, the pointed sections of the two individual border section pieces that come together can be folded over and then secured (anchored) to the border section 120 by using a stitch or the like. Instead of having folded edges, the border section 120 can be constructed so that it has another type of non-sharp edge, such as a rounded edge or the like.

The dimensions of the entire table cloth 100 as well as the individual dimensions of the first section 110 and the border section 120 are entirely variable depending upon the specific application or need of the user. For example, the relative surface area between the first section 110 and the border section 120 is variable in that the amount of border section 120 for a given first section 110 can be varied. In other words, the table cloth 100 can be constructed to have a larger or smaller border section 120 relative to the first section 110. Of course, the dimensions of the table cloth 100 are typically selected in view of the dimensions of the table itself. In one embodiment, the table cloth 100 has dimensions of 30″×30″ or 40″×40″; however, these dimensions are merely exemplary and it can come in any number of other dimensions.

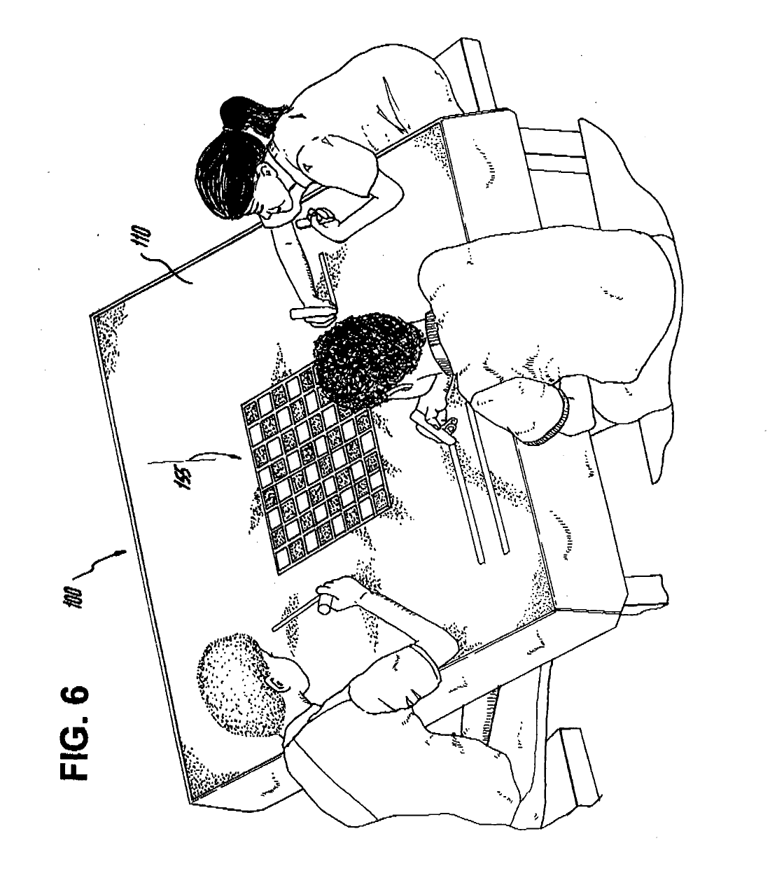

While the writing surface (first face 112) can resemble a blank slate on which the user can write or draw with chalk, the writing surface 112 can also be formed so that it contains a number of indicia that are associated therewith. For example and according to one embodiment illustrated in FIG. 6, the writing surface 112 includes printed indicia formed as a part thereof to provide educational and/or entertainment value. In the illustrated embodiment, the writing surface 112 includes a printed indicia 155 in the form of a game board, such as a checker board or chess board. Preferably, the printed indicia 155 does not occupy a significant amount of the writing surface 112 so that there is still a free, usable writing surface 112 that surrounds the printed indicia 155. This free writing surface 112 permits the user (game player) to jot notes down during play of the game. For example, the game players can construct a scoreboard to list players' names and the number of games won, etc. Other notes related to the game can also be scribbled on the writing surface 112.

The printed indicia 155 can be formed of any number of different materials that are compatible with and able to be securely attached to the first face 112 using conventional techniques. In FIG. 7, for example, the printed indicia 155 can be formed of a polymeric material and can be attached to the first face 112 using a heat transfer printing process. In this embodiment, the printed indicia 155 is permanent and can not be removed or otherwise repositioned on the first face 112.

The printed indicia 155 turns the writing surface into an interactive writing surface since the user can now play and learn by writing over the writing surface 112. For example, the printed indicia 155 can be in the form of an interactive game such as tic tac toe or hang man which provides not only entertainment to the player but also enhances certain motor skills of the player. In other words, it has educational value since the player needs to develop and react to different strategies and can lead to an enhancement in vocabulary, etc.

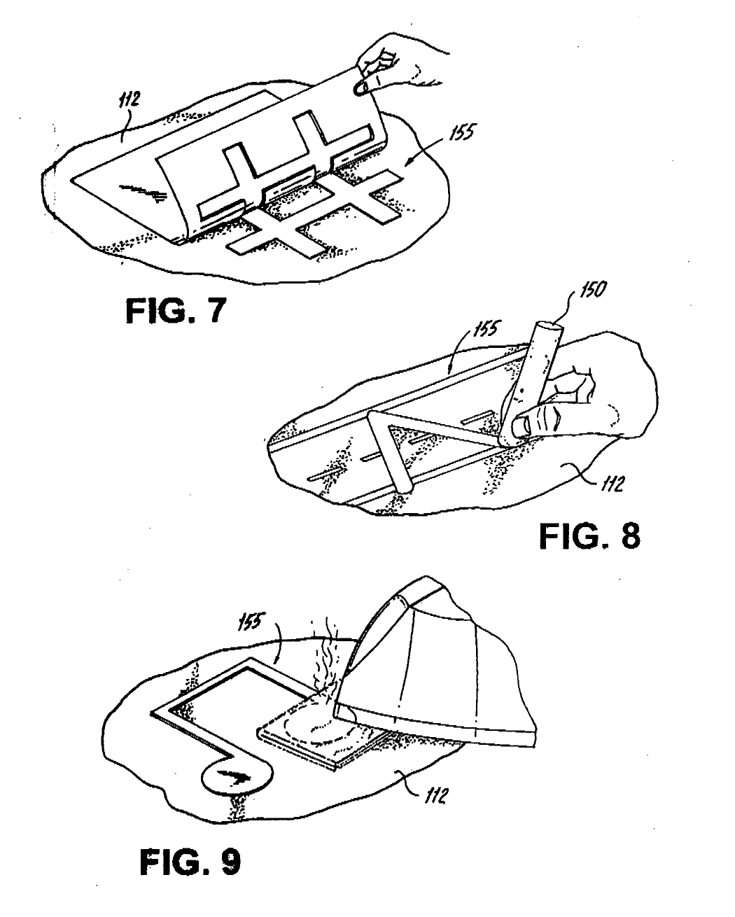

It will also be appreciated that the printed indicia 155 is not limited to game boards or the like and can instead take any number of different forms, including educational, sports, corporate logos, musical, religious, etc. For example, as shown in FIG. 8, the printed indicia can be in the form of compositional writing lines that permit the user to practice writing letters and/or words. For example, it is conventional practice for a child to practice block writing or cursive writing by writing individual letters within set lines that are part of the composition paper and therefore, this type of printed indicia 155 permits the child to practice writing in a manner in which the writing can be easily erased on the writing surface 112. Similarly, a music bar can be printed on the writing surface to permit the user to write musical notes thereon as part of practicing writing the various musical notes or as part of composing a song or the like.

When the table cloth 100 is provided in a commercial establishment such as a restaurant, day care center, hospital, doctor's office, golf range, etc., the printed indicia 155 can be in the form of a corporate logo or the like. For example, a restaurant logo can be formed around the border section 120 when the table cloth 100 is used in the restaurant or even when it is given away by the restaurant as a gift, thereby serving as advertising.

While the indicia 155 can be already be printed on the writing surface 112, other suitable indicia that is for permanent placement on the writing surface 112 is in the form of a decal that can be attached using a heat transfer technique, e.g., ironing the decal on the writing surface 112, as shown in FIG. 9. The decal can come in a set or package of decals so that the user can select which decal(s) to place on the writing surface. The decals can be packaged according to a theme, such as sports, flowers, music, letters, etc., or the decals can be packaged as a random assortment of decals.

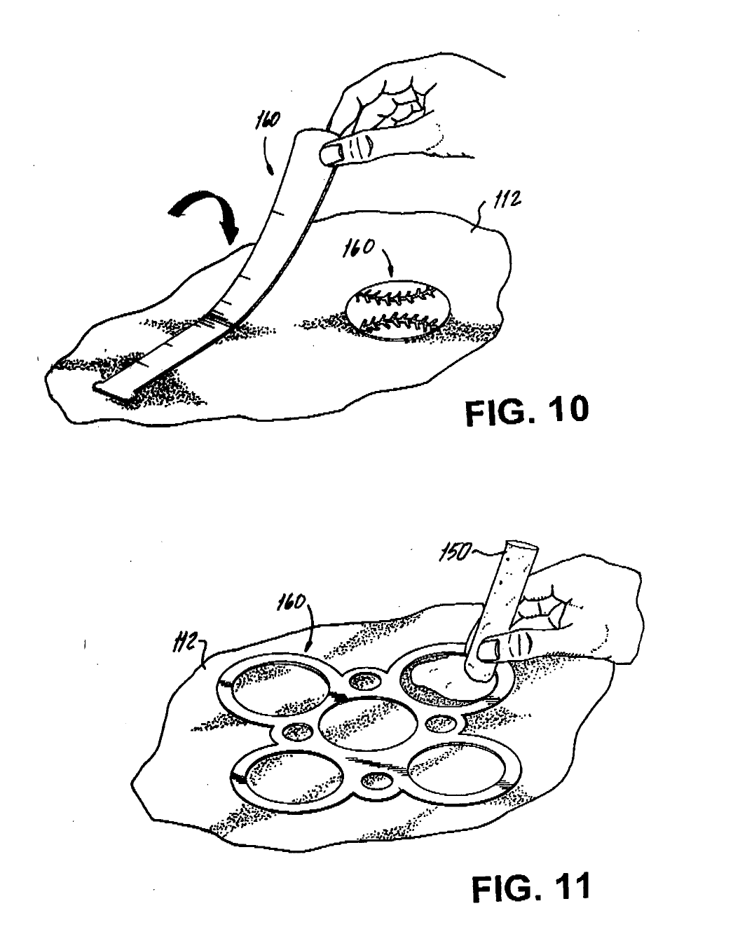

In yet another embodiment, removable indicia 160 is provided for placement on the writing surface in a removable manner as shown in FIG. 10. The removable indicia 160 can be in the form of static cling type decals or any other type of decals that can be applied to the writing surface 112 such that they maintain their position on the writing surface 112 but can easily be removed by the user at any given time. As with the printed indicia 155, the static cling indicia 160 can convey any number of different themes. For example, the indicia 160 can be a board game, sports related, a corporate logo or the like, religious, musical or educational learning tools, etc.

In one embodiment shown in FIG. 11, the removable indicia 160 is in the form of a coloring mask in that the indicia 160 includes more or more contoured cut out section that provides a defined coloring area for the user. The indicia 160 is simply placed on the writing surface 112 at a desired location and then the user simply colors within the empty cut outs onto the writing surface 112. It will be appreciated that the user may use a different color for each individual cut out resulting in the final colored image being multi colored. In this manner, the indicia 160 acts as a mask in that it permits the user to color within a bounded area resulting in the colored image being very clearly defined and pleasing to the child. The mask thus teaches the child to color within a bounded area as opposed to coloring all over the writing area. When the removable indicia 160 takes this form, the coloring mask can take any number of different forms, including superheroes, cartoon personalities, animals, etc. Because the indicia 160 is removable and repositionable, the user can easily move the mask around until it is disposed in a desired location which can vary from application to application.

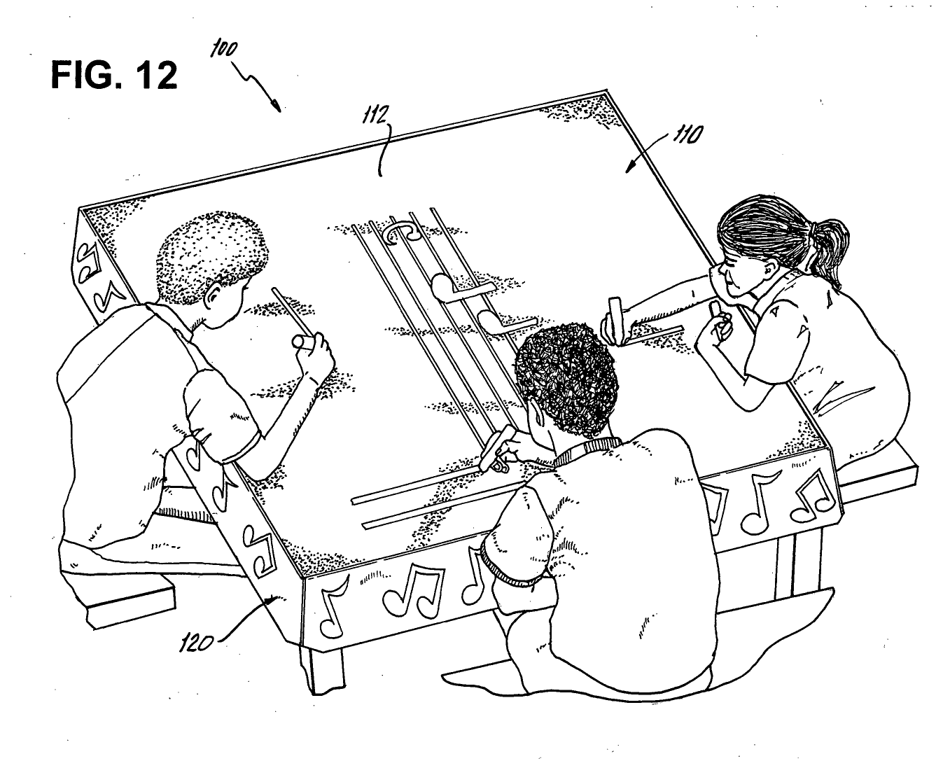

In yet another embodiment shown in FIG. 12, the border section 120 can include indicia relating to a first theme and the first section 110 includes indicia relating to an activity associated with the first theme on the border section 120. For example, when a musical bar is either pre-printed on the writing section 112 or is removably disposed on the writing surface, musical indicia can be provided as part of the border section 120. In other words, the border section 120 can include printed musical indicia, such as musical notes or instruments, and the writing section includes the musical bar which provides an interactive learning tool for the child. This is one example where a music theme is conveyed by the table cloth 100. When the table cloth 100 has a sports theme, the border section 120 can have sports related indicia, such as a favorite team logo or a picture of a helmet or uniform, while the writing section 112 has sports indicia that relates to the indicia on the border section 120. The border section 120 and the indicia on the writing surface 112 can also convey a religious theme and therefore, it can include scriptures or other religious sayings as well as an interactive section where the child can learn to write and remember various religious hymns, etc.

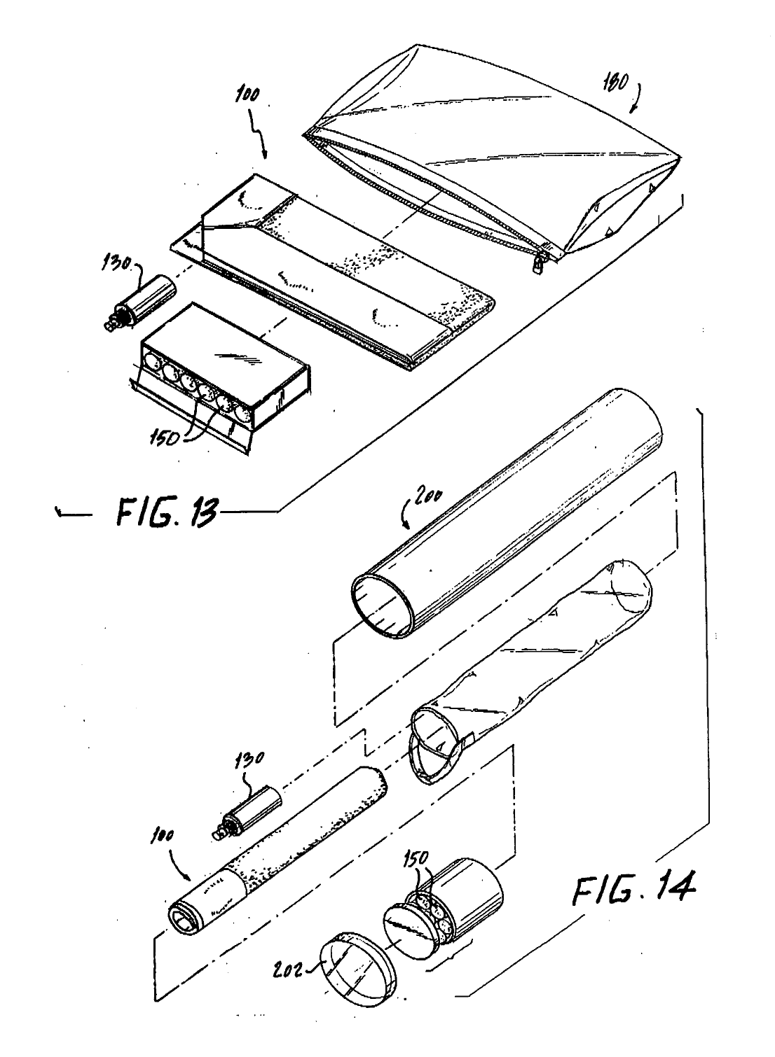

It will further be appreciated that while the foregoing embodiment has been discussed in terms of a table cloth, it may also be constructed in the form of a place mat or other item that is typically used on a substrate surface, such as a table. Thus, the present embodiments are not limited to merely being in the form of a table cloth but rather they can be embodied in any number of different types of articles of manufacture. The table cloth 100 and any kit components, such as spray bottle 130 or chalk and eraser, is conveniently packaged so it is compact and can be easily transported from one location to a next. For example as shown in FIG. 13, the table cloth 100 can be folded along fold lines into a folded square or rectangular member which is then disposed in a transparent bag, pouch, or the like 180 that has a zipper to contain the table cloth 100 and other items therein. Alternatively, as shown in FIG. 14, the table cloth 100 and the other items can be stored in a tube or the like 200. The table cloth 100 is rolled so that it can be received within the open tube. By rolling the table cloth 100, many of the fold lines and/or creases can be eliminated and therefore, the table cloth 100 should lay more cleanly when placed on a support surface. An end body plug 202 is then disposed in the open end of tube 200 to contain the contents therein. The end body plug 202 can be formed of a transparent material to permit a potential purchaser to view the contents. Thus, the purchaser can view the color combinations of the first section 110 and the border section 120 to see if the combination is appealing or desirable to the purchaser.

While the various embodiments have been discussed in terms of using standard chalk (calcium carbonate), it will be appreciated that water based markers can be used instead of chalk. It will also be appreciated that the border section can be more in the form of a binding that is disposed around the periphery of the substrate (oil cloth) as opposed to the larger border section 120 shown in the figures.

The articles disclosed herein can also be used in an institutional setting, such as on cruise ships, airlines, and in corporations, etc. In yet another embodiment, the guide that is formed on the first section 110 is in the form of instructional material that preferably has some relation to the location of where the article is being used or offered. For example, the guide can be in the form of a recipe (food or drink) that is common to the restaurant or establishment where the article is being used or conveyed. For example, articles 100 used at a Mexican restaurant can have guides in the form of recipes for making margarita drinks and salsa dip. The recipes can have some interactivity since they can include a check box next to each ingredient and/or step so that the user can simply check off when the ingredient has been added or the step completed.

While exemplary drawings and specific embodiments of the present invention have been described and illustrated, it is to be understood that the scope of the present invention is not to be limited to the particular embodiments discussed. Thus, the embodiments shall be regarded as illustrative rather than restrictive, and it should be understood that variations may be made in those embodiments by workers skilled in the art without departing from the scope of the present invention as set forth in the claims that follow, and equivalents thereof. In addition, the features of the different claims set forth below may be combined in various ways in further accordance with the present invention.

1. An interactive table cloth comprising:
a foldable substrate processed to receive chalk on a writing surface thereof and being washable and formed of an oil cloth material that has one face that is processed so that the user can write with chalk thereon and at the same time, the chalk is easily erased therefrom;
a border formed around and attached to a peripheral edge of the substrate, the border being formed of a second material that is different from the oil cloth material; and
a guide that is a permanent part of the writing surface by being attached to the oil cloth material and being indicative of where chalk is to be applied, the guide being formed of a third material different than the oil cloth material.

2. (canceled)

3. The table cloth of claim 1, wherein the border is formed of a polymeric material that has a glossy finish on one face.

4. The table cloth of claim 1, wherein the border has a pattern formed thereon that is selected from the group consisting of: zigzag, striped, checker board, plaid and geometric.

5. The table cloth of claim 1, wherein the border is attached to the peripheral edge of the substrate such that a sealed lip edge is formed around the periphery of the substrate and is defined by a folded section of the border.

6. The table cloth of claim 5, wherein the border is attached to the peripheral edge of the substrate by a turn down hem stitch.

7. The table cloth of claim 1, wherein the guide comprises indicia that is permanently bonded to the writing surface by a heat transfer process.

8. The table cloth of claim 1, wherein the guide has an educational theme.

9. The table cloth of claim 1, wherein the guide is in the form of a game board selected from the group consisting of tic-tac-toe, chess, checkers, and hang man.

10. The table cloth of claim 1, wherein the border section includes first indicia formed thereon and associated with a first theme which is the same as a theme of the guide printed On the writing surface.

11. The table cloth of claim 1, wherein the guide is in the form of parallel lines to assist the user in practicing writing skills.

12. The table cloth of claim 1, wherein the guide is in the form of a music bar to assist the user in practicing writing musical notes or songs.

13. An interactive educational kit comprising:
a table cloth including:
a foldable substrate processed to receive chalk on a writing surface thereof and being washable so as to permit erasing of any chalk marks made on the substrate such that the substrate appears substantially new after cleaning, the substrate being formed of an oil cloth material that has one face that is processed so that the user can write with chalk thereon;
a border formed around and attached to a peripheral edge of the substrate, the border being formed of a material that is different from the oil cloth; and
a guide disposed on the on the writing surface and being indicative of where a writing medium is to be applied on the writing surface;
a writing implement in the form of the chalk which is of the type that can be transferred onto the writing surface and be freely erased therefrom;
a container that is open at a first end for receiving and holding the table cloth in a rolled condition;
an end plug for holding the writing implement, the end plug being received within the container after the rolled table cloth is received therein so as to close the open first end of the container and secure all contents of the container; and
wherein the border section has a feature formed as an integral part thereof for receiving and holding the writing implement and the container.

14. The table cloth of claim 13, wherein the guide is formed of a material that permits the guide to be freely removed from the writing surface after it has been laid down and held onto the writing surface.

15. The table cloth of claim 14, wherein the removable guide comprises one or more static cling decals.

16. The kit of claim 13, wherein the writing implement comprises two or more pieces of different colors chalk.

17. The kit of claim 13, further including a spray bottle that holds a liquid for cleaning the writing surface, the spray bottle being received within the container.

18. The kit of claim 13, wherein the feature is a pocket that is integrally formed as part of the border section and includes a closed end and an open end for receiving the chalk and the container.

19. The kit of claim 13, wherein the feature is a hook and loop fastener formed of a pair of pads having one of a hook construction and a loop construction and a strap that is of a sufficient length to extend between the pair of pads and having an opposite construction compared to the pair of pads, wherein the chalk and the container are received between the pair of pads and are held in place against the border section by means of the strap that mates at its ends with the pair of pads.

20. The kit of claim 13, wherein the border section has folded corners so as to be free of sharp edges.

21. The kit of claim 13, wherein the border is attached to the peripheral edge of the substrate such that a sealed lip edge is formed around the periphery of the substrate and is defined by a folded section of the border.

22. The kit of claim 13, wherein the border is attached to the peripheral edge of the substrate by a turn down hem stitch.

23. The kit of claim 13, wherein the guide comprises indicia that is permanently bonded to the writing surface by a heat transfer printing process.

24. The kit of claim 13, wherein the border section is attached to the peripheral edge of the substrate along a folded edge of the border such that any cleaning fluid that is present on the writing surface is contained within a perimeter of the border section.

25. The kit of claim 13, wherein a rear face of each of the substrate and the border section includes a cloth mesh formed thereon to increase robustness and ease of cutability of the border section, respectively.

26. The kit of claim 13, wherein the guide is in the form of a coloring mask for placement on the writing surface, the mask including a number of openings formed therein that expose the writing surface when the mask is laid down on the writing surface to indicate locations where the writing medium is to be applied.

27. (canceled)

28. The kit of claim 13, wherein the border is attached to the peripheral edge of the substrate along a folded edge of the border such that any cleaning fluid that is present on the writing surface is contained within a perimeter of the border and is prevented from flowing between an interface between the folded border and the substrate; and
wherein indicia is formed on the border and has an associated theme which is also conveyed in the guide printed on the writing surface.

29. The kit of claim 28, wherein the theme is selected from the group consisting of: education; music; sports; religious; corporate logo and board games.

30. The kit of claim 28, wherein the article is one of a table cloth and a placemat.

31. The kit of claim 28, wherein the guide is a recipe that offers instructions as to preparing food or drink.

32. The kit of claim 13, wherein dimensions of the foldable substrate and a location of the peripheral edge of the substrate are selected so that when the table cloth is placed on a table, the peripheral edge of the substrate is located proximate the edge of the table and the border drapes down over the edge of the table.

33. The kit of claim 13, wherein the end plug comprises a canister that receives and holds the writing implement and a cover that is positioned across an open end of the canister and closes off the open end of the container.
